(19) United States
(12) Patent Application Publication
(10) Pub. No.: US 2026/0140310 A1
(43) Pub. Date: May 21, 2026

(54) FLEXIBLE PHOTONIC CRYSTAL PANEL

(71) Applicant: Christian-Albrechts-Universitaet zu Kiel, Kiel (DE)

(72) Inventors: Martina Gerken, Kiel (DE); Fabio Aldo Kraft, Kiel (DE); Johannes Blaesi, Kiel (DE)

(21) Appl. No.: 18/881,681

(22) PCT Filed: Jun. 27, 2023
(86) PCT No.: PCT/DE2023/100482

§ 371 Date: Jan. 6, 2025

(30) Foreign Application Priority Data
Jul. 7, 2022 (DE) 10 2022 117 029.2

(51) Int. Cl. G02B 6/122; B82Y 20/00; G02B 6/12; G02B 6/13

(52) U.S. Cl. CPC G02B 6/1225; B82Y 20/00; G02B 6/13; G02B 2006/12054; G02B 2006/12057; G02B 2006/12173; G02B 2006/12176

(57) ABSTRACT

A stretchable photonic crystal panel, wherein the panel exhibits a percentage change of the optical resonance wave of less than 0.2%, standardized to the percentage stretch. The stretchable photonic crystal panel includes a stretchable substrate layer (1) and a nanostructured waveguide layer (2), wherein the waveguide layer (2) has polygonal portions (3), which are delimited by stretch channels (4), and wherein the polygonal portions (3) have a size between 2 μm and 1 mm.

The present invention relates to flexible photonic crystal slabs (f-PCS), their production and use as flexible sensors for monitoring the human body.

Flexible photonic crystal slabs (Flexible Photonic Crystal Slab f-PCS) are described in CN101201540A, JP2007193286A and also in [Karrock, T., Paulsen, M., & Gerken, M. (2017). Flexible photonic crystal membranes with nanoparticle high refractive index nanoparticle layers. Beilstein Journal of Nanotechnology, Vol. 8(1), 2017, 203-209. ISSN 2190-4286 (E) DOI: https://doi.org/10.3762/bjnano.8.22 URL: https://www.beilstein-journals.org/bjnano/content/pdf/2190-4286-8-22.pdf] known. Stretching the photonic crystal slabs changes the photonic crystal's optical resonance wavelength.

US 2022/0042905 A1 claims artificial optical devices that exhibit a change in optical properties, particularly color, when stretched or heated. The devices are constructed from a layer of flexible polymer and several segments on top of it, which are also flexible in themselves and contain photonic crystals.

The Japanese patent JP5946052B2 proposes multilayer photonic crystals with a sublayer of lower refractive index to suppress background effects.

Hu et al., “Flexible integrated photonics: where materials, mechanics and optics meet [Invited]”, Opt. Mater. Express 3, 2013, pp. 1313-1331, provides an overview of the mechanical design principles and material processing of flexible photonic crystal slabs.

U.S. Pat. No. 11,161,276 B2 describes a 3D printing process for manufacturing one-dimensional flexible photonic crystals for monitoring the human body.

The described flexible photonic crystal slabs (Flexible Photonic Crystal Slab f-PCS) can be used as sensors. They have in common that strain or temperature increase leads to an immediate change in the optical properties by changing the optical resonance wavelength.

When monitoring the human body, an immediate change in optical properties is disadvantageous, since a certain degree of deformation may be desired without a detectable change in optical properties occurring. This is the case, for example, with “intelligent” wound dressings or plasters, where the patient or athlete should be allowed a certain degree of freedom of movement without the detection sending a signal too early or being compromised.

Therefore, the invention is to provide new flexible photonic crystal slabs (Flexible Photonic Crystal Slab f-PCS).

In particular, the invention is to provide new flexible photonic crystal slabs (Flexible Photonic Crystal Slab f-PCS) that retain their optical properties to a large extent at lower strain.

In particular, the invention is to provide new flexible photonic crystal slabs (Flexible Photonic Crystal Slab f-PCS) that have a percentage change in the optical resonance wave of less than 0.2% normalized to the percentage strain.

The object of the invention is achieved by a multilayer flexible photonic crystal slab (f-PCS) which has a percentage change of the optical resonance wavelength of less than 0.2%, normalized to the percentage strain, the flexible photonic crystal slab has a flexible substrate layer (1) and a nanostructured waveguide layer (2), the waveguide layer consisting of portions (3) bounded by strain grooves (4), and the portions (3) having a size between 2 μm and 1 mm.

In a particular embodiment, the nanostructured waveguide layer is formed from materials selected from the group consisting of titanium dioxide (TiO₂), niobium pentoxide (Nb₂O₅) and tantalum pentoxide (Ta₂O₅).

In another particular embodiment, the flexible substrate layer also has a nanostructure.

In a preferred embodiment, the flexible photonic crystal slab comprises, in addition to the flexible substrate layer and the nanostructured waveguide layer, one or more sublayers.

In another preferred embodiment, the sublayers are low-index layers.

In another particular embodiment, the sublayers are formed of silicon oxide (SiO₂) material.

In another embodiment, the flexible photonic crystal slab has at least one superlayer (6).

In a particular embodiment, the material for the superlayers is selected from the group consisting of gold (Au) and/or silicon dioxide (SiO₂).

The advantage of choosing SiO₂ as a material for the superlayer is that it allows for good bonding of silanes. If gold is chosen as the material for the superlayer, there is a good possibility for bonding thiols.

In a further aspect of the invention, the problem is solved by a method comprising the following steps:
i. forming the flexible substrate layer by
   a. casting a master mold,
   b. degassing and
   c. then allowing to harden
ii. optionally, depositing a sub-layer on the flexible substrate layer formed in step i by the method of cathode sputtering
iii. depositing a high-index waveguide layer on the flexible substrate layer produced in step i or in step ii by the method of cathode sputtering
iv. producing the strain grooves in the waveguide layer by
   a. mechanical loading or
   b. lithographic methods or
   c. with the aid of masks,
   in which strain grooves in the range of 0.5 μm to 1 mm can be specifically set using the lithographic method (iv. b.) or the use of masks (iv. c.).

The effect of stable optical properties under strain can be attributed to the strain grooves, which absorb a large part of the mechanical deformation, leaving the portions unaffected.

FIG. 4 shows a multilayer flexible photonic crystal slab (f-PCS) according to the invention under strain. The strain groove (4′) widens and thus absorbs the mechanical strain, the portions (3) remain largely unaffected in their extent.

Table 1 shows the shift in the resonance wavelength with strain for f-PCS according to the invention without a sub-layer (sample 1), with a sub-layer (sample 2) and for a non-invention-based fully flexible photonic crystal (sample 3), as also described in [Karrock, T., Paulsen, M., & Gerken, M. (2017). Flexible photonic crystal membranes with nanoparticle high refractive index nanoparticle layers. Beilstein Journal of Nanotechnology, 8(1), 203-209. https://doi.org/10.3762/bjnano.8.22] is also described.

TABLE 1
Measurements of optical properties at elongation for f-PCS

| | | Shift. | | | | | |
|---|---|---|---|---|---|---|---|
| | Resonance | maximal | Relative | bearing | Stretching | Strain | Shift/Strain |
| Typ | [nm] | [nm] | change [%] | [mm] | [μm] | [%] | [%/%] |
| 1 | 638.5 | 1.9 | 0.3 | 8.7 | 500 | 6 | 0.05 |
| 1 | 655.8 | 3.7 | 0.6 | 8.7 | 500 | 6 | 0.1 |
| 1 | 590.7 | 0.4 | 0.06 | 7.5 | 500 | 7 | 0.008 |
| 2 | 598.8 | 0.4 | 0.07 | 12.9 | 1000 | 8 | 0.008 |
| 2 | 646.5 | <0.1 | 0.01 | 8.6 | 500 | 6 | 0.002 |
| 3 | 585 | 15 | 2.6 | — | — | 4 | 0.65 |

In a fully flexible photonic crystal, a 1% change in the lattice period L and thus also a change in the resonance wavelength l0 of approx. 1% is expected at a strain of 1%. In [Karrock, T., Paulsen, M., & Gerken, M. (2017). Flexible photonic crystal membranes with nanoparticle high refractive index nanoparticle layers. Beilstein Journal of Nanotechnology, 8(1), 203-209. https://doi.org/10.3762/bjnano.8.22] shows this correlation.

The f-PCS according to the invention show a significantly smaller percentage change of the optical resonance wavelength—and thus of the optical properties—upon stretching than is the case with sample 3.

All f-PCS according to the invention show a percentage change of the optical resonance wavelength of less than 0.2% normalized to the percentage strain.

The f-PCS according to the invention with sub-layer (sample 2) shows the smallest value (0.002) for the percentage change of the resonance wavelength normalized to the strain and a better noise suppression than the f-PCS according to the invention without sub-layer (sample 1).

### DESCRIPTION OF FIGURES

FIG. 1 shows the flexible photonic crystal slab with substrate layer (1) and nanostructured waveguide layer (2) according to the invention, wherein the waveguide layer consists of portions (3) that are bounded by stretching grooves (4).

FIG. 2 shows the flexible photonic crystal slab according to the invention, with a sublayer (5) between the flexible substrate layer (1) and the nanostructured waveguide layer (2).

FIG. 3 shows the flexible photonic crystal slab according to the invention, with a superlayer (6) on the nanostructured waveguide layer (2).

FIG. 4 shows a multilayer flexible photonic crystal slab (f-PCS) according to the invention under strain. The strain groove (4′) widens and thus absorbs the mechanical strain, the portions (3) remain largely unaffected in their extent.

FIG. 5 shows a plot of the spectral optical properties of f-PCS without a sub-layer when stretched perpendicular to the lattice orientation of the one-dimensional periodic nanostructure. For this purpose, the sample was clamped in a stretching device for characterization. 0 μm displacement of the micrometer screw corresponds to 0% strain. Turning the micrometer screw displaces a clamping jaw of the stretching device and stretches the sample. The measured wavelength of the resonance at this strain is shown above. The spectra for the unstretched sample and two stretching states are shown below. It can be clearly seen that the resonance changes only minimally in wavelength.

FIG. 6 shows a plot of the spectral optical properties of f-PCS without a sublayer when stretched parallel to the lattice of the one-dimensional periodic nanostructure. For this, the sample was clamped in a stretching device for characterization. 0 μm displacement of the micrometer screw corresponds to 0% strain. Turning the micrometer screw displaces one of the clamping jaws of the stretching device and stretches the sample. The measured resonance wavelength at this strain is shown above. The spectra for the unstretched sample and two stretched states are shown below. It can be clearly seen that the resonance changes only minimally in wavelength.

FIG. 7 shows the clamping device with an f-PCS clamped between two jaws and a micrometer screw for adjusting the strain (left image); the portions of the f-PCS according to the invention can be seen in the center image in a relaxed state; the surface of the f-PCS according to the invention can be seen in the image on the right under strain (in this case 6%).

FIG. 8 shows a representation of the spectral optical properties of f-PCS under strain perpendicular to the lattice of the one-dimensional periodic nanostructure of an f-PCS with a sublayer of 100 nanometers of SiO₂. For the characterization, the sample was clamped in a stretching device. 0 μm displacement of the micrometer screw corresponds to 0% strain. Turning the micrometer screw displaces a clamping jaw of the stretching device and stretches the sample. Spectra are shown for the unstretched sample and two states of stretching. It can be clearly seen that the resonance changes only minimally in wavelength.

FIG. 9 shows a plot of the spectral optical properties of f-PCS under strain parallel to the lattice of the one-dimensional periodic nanostructure of an f-PCS with a sublayer of 100 nanometers of SiO₂. For the characterization, the sample was clamped in a stretching device. 0 μm displacement of the micrometer screw corresponds to 0% strain. Turning the micrometer screw displaces a clamping jaw of the stretching device and stretches the sample. Spectra are shown for the unstretched sample and two stretched states. It can be clearly seen that the resonance changes only minimally in wavelength.

FIG. 10 shows the surface of an f-PCS according to the invention with a sublayer of 100 nanometers of SiO₂. The image on the left was taken in the relaxed state and the image on the right in the stretched state (in this case 5%).

Without restricting the general nature of the teaching, examples are described below.

The f-PCS without a sublayer are produced as follows. Polydimethylsiloxane (PDMS, manufacturer Dow Chemical, product name Sylgard 184) is stirred in a ratio of eight to one (elastomer to hardener) for twenty minutes. The ULTRA_TURRAX Tube Drive mixer from IKA is used for mixing. After twenty minutes of stirring, the PDMS is degassed. To do this, the PDMS is exposed to a vacuum for twenty minutes until no more bubbles form and a clear liquid is visible. This liquid is now placed on a nanostructured master. The master was produced by AMO GmbH using interference lithography. The nanostructure of the master has a period of 370 nm and a lattice depth of 30 nm, 45 nm or 60 nm. This master is placed in a basin so that the nanostructure is facing upwards. The PDMS is tilted onto the master until it is completely covered. The master and the PDMS are then baked at 130° C. for 30 minutes. The T6060 oven from Heraeus is used for this purpose. After baking, the now hardened PDMS is cooled for one hour. After cooling, the master and the PDMS are cut out of the basin with a scalpel and carefully separated from each other. The PDMS is now embossed with the negative form of the nanostructure. In the next step, the nanostructured PDMS is attached to a holder for the sputter system using Kapton tape and installed in the sputter system. The sputter system is the model nano36 from the company Kurt J. Lesker. It can be equipped with up to three targets. After evacuating the sputter system, a high-index layer of Nb₂O₅ (company: Kurt J. Lesker, EJUNBOX353TK 4) or TiO₂ (company: Kurt J. Lesker, EJUTIO2403TK4) is applied to the PDMS by RF sputtering. The layer thickness is between 60 nm and 100 nm. After the sputtering process, the PDMS substrates are removed from the sputtering system. Subsequently, the portions are generated by breaking the high-index layer under mechanical stress.

The f-PCS with a sublayer are produced as follows. Polydimethylsiloxan (PDMS, manufacturer Dow Chemical, product name Sylgard 184) is mixed in a ratio of eight to one (elastomer to hardener) for twenty minutes. The mixer ULTRA_TURRAX Tube Drive from IKA is used for mixing. After twenty minutes of stirring, the PDMS is degassed. To do this, the PDMS is exposed to a vacuum for twenty minutes until no more bubbles form and a clear liquid is visible. This liquid is now placed on a nanostructured master. The master was produced by AMO GmbH using interference lithography. The nanostructure of the master has a period of 370 nm and a lattice depth of 30 nm, 45 nm or 60 nm. This master is placed in a basin with the nanostructure facing upwards. The PDMS is tipped onto the master until it is completely covered. The master and the PDMS are then baked at 130° C. for 30 minutes. The T6060 oven from Heraeus is used for this. After baking, the now hardened PDMS is cooled for one hour. After cooling, the master and the PDMS are cut out of the basin with a scalpel and carefully separated from each other. The PDMS is now embossed with the negative form of the nanostructure. In the next step, the nanostructured PDMS is attached to a holder for the sputter system using Kapton adhesive tape and installed in the sputter system. The sputter system is the model nano36 from the company Kurt J. Lesker. It can be equipped with up to three targets. After evacuating the sputter system, a low-index layer of SiO₂ (company: Kurt J. Lesker, EJUSIO2453TK4) is first applied by means of RF sputtering. After that, the high-index layer Nb₂O₅ (company: Kurt J. Lesker, EJUNBOX353TK 4) or TiO₂ (company: Kurt J. Lesker, EJUTIO2403TK4) is applied to the low-index layer by RF sputtering. The layer thickness is between 60 nm and 100 nm. After the sputtering process, the PDMS substrates are removed from the sputtering system. Subsequently, the portions are generated by breaking the high-index layer under mechanical stress.

The samples are measured in the same way for both f-PCS variants. The f-PCS is attached to a strain holder between two clamping jaws. One of the clamping jaws is movable and can be moved by a micrometer screw (Mitutoyo, 102-301). The holder is positioned on a transmitted light microscope (Nikon Eclipse Ti-U) and illuminated with white light (Nikon D-LH/LC). The strain holder is located between two linear polarizing filters that suppress the excitation light and only transmit the f-PCS resonance. The f-PCS resonance is then directed either to a spectrometer or to a Nikon camera (Nikon Digital Camera D5100). Now the f-PCS is stretched in defined steps by turning the micrometer screw further (e.g. in 100 μm steps). After each step, a spectrum and an image are recorded. The spectra are evaluated retrospectively by tracking the change in the peak position of the resonance compared to the strain using fitting algorithms. The images provide information about the extent of the lateral displacement of the portions caused by the strain.

### LIST OF FIGURES

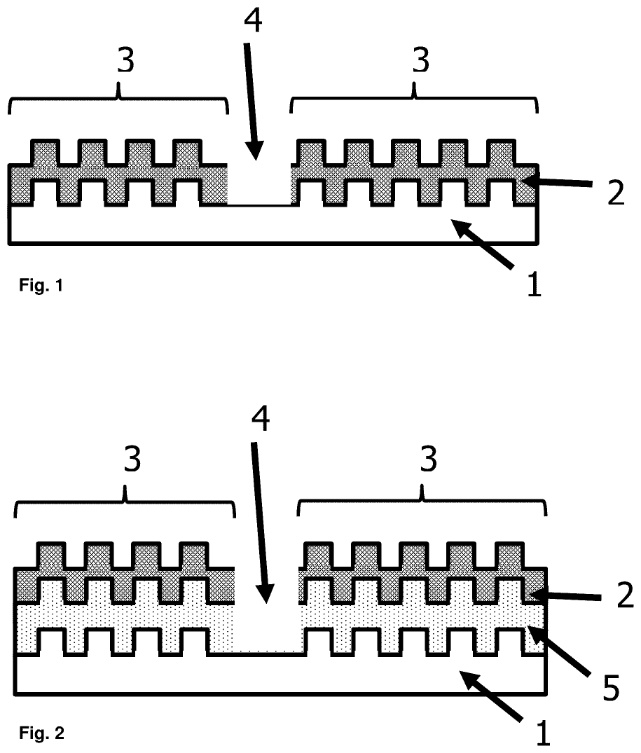

FIG. 1 Flexible photonic crystal slab according to the invention;

FIG. 2 Flexible photonic crystal slab according to the invention with sublayer;

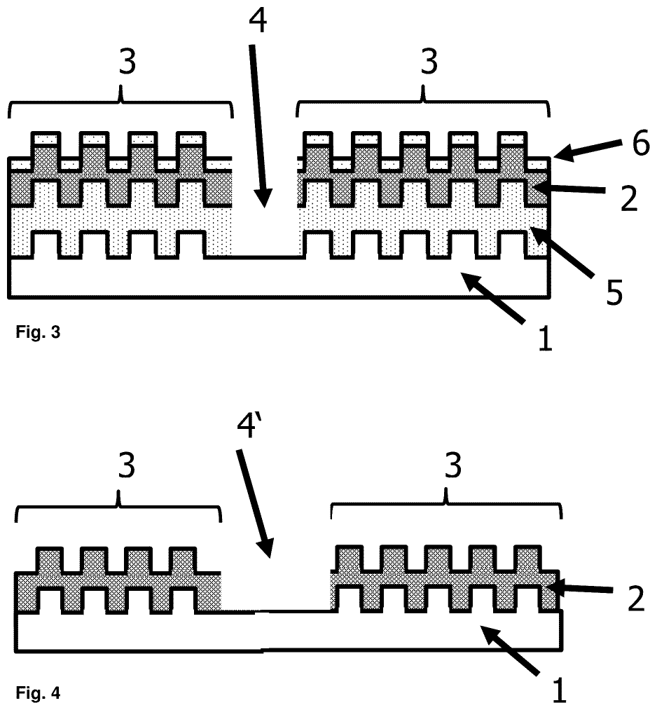

FIG. 3 Flexible photonic crystal slab according to the invention with superlayer;

FIG. 4 Flexible photonic crystal slab with a widened strain groove according to the invention;

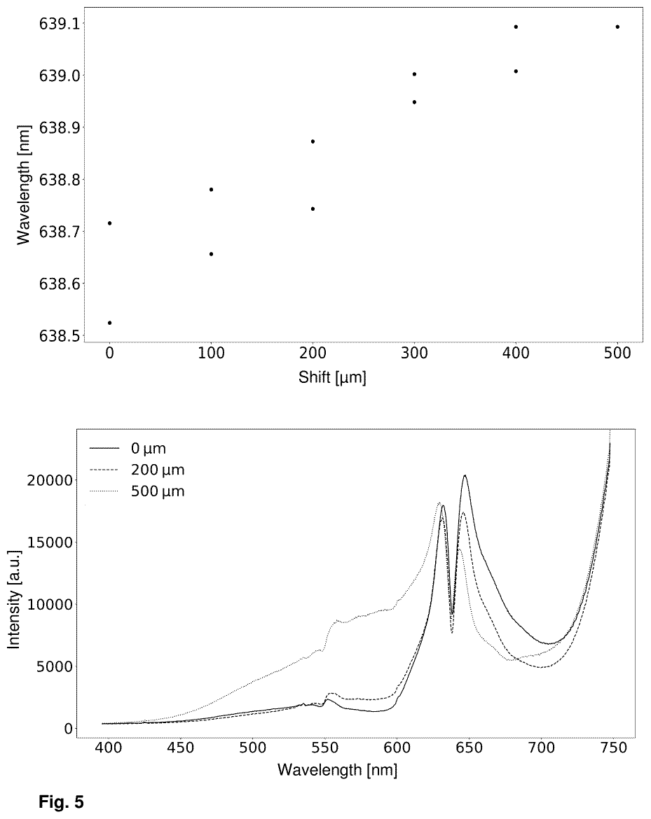

FIG. 5 Representation of the optical stability of f-PCS without a sublayer when stretched transversely to the lattice orientation. The resonance shift is shown above when stretched horizontally. The spectral behavior is shown below;

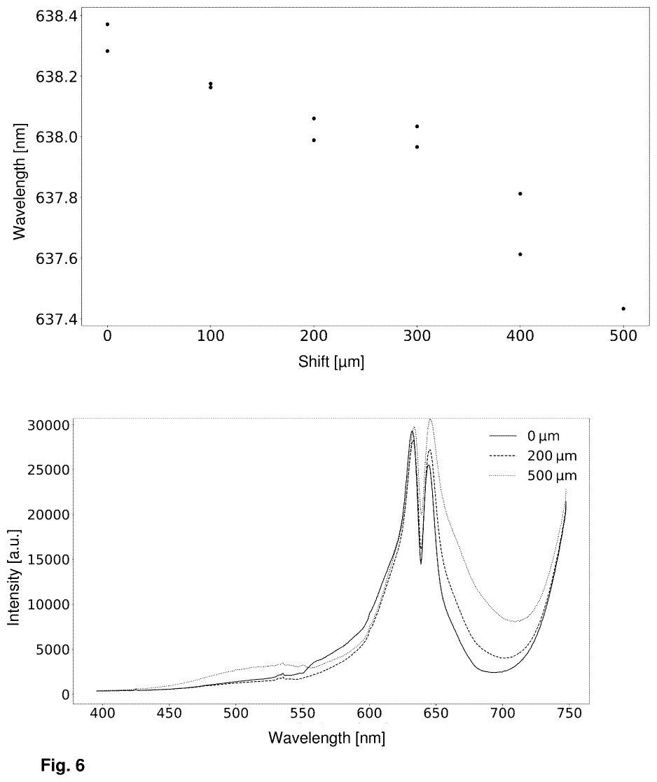

FIG. 6 Optical stability of f-PCS without sublayer when stretched parallel to the lattice. The resonance shift is shown above for parallel stretching. The spectral behavior is shown below;

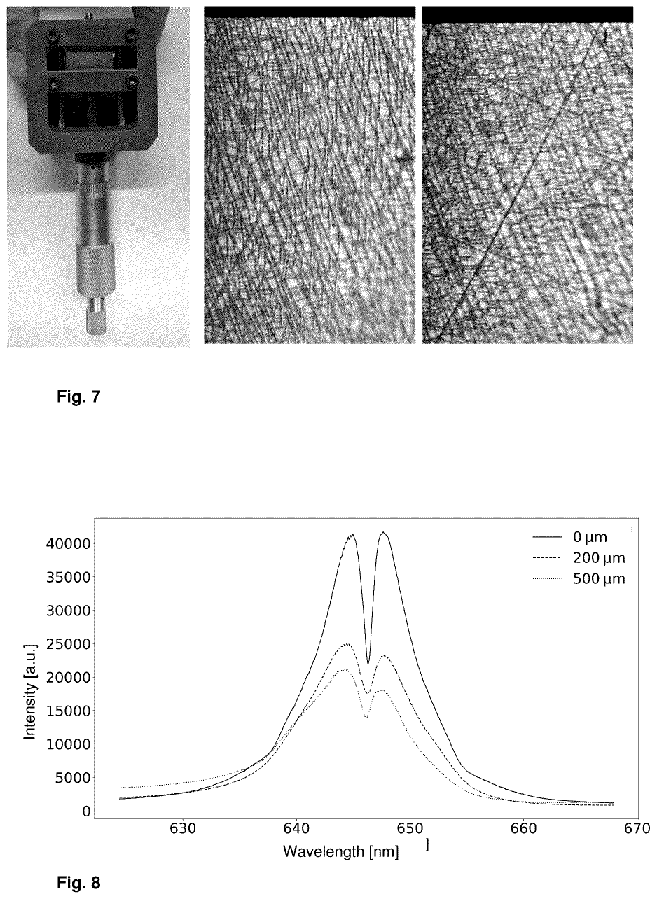

FIG. 7 Left image shows the strain holder (clamping device) with an f-PCS. The middle image shows the flake structure on the f-PCS in a relaxed state. The right image shows the flake structure under strain (in this case 6%);

FIG. 8 Representation of the spectral behavior at strain perpendicular to the lattice direction at f-PCS with a sublayer of 100 nanometers SiO₂;

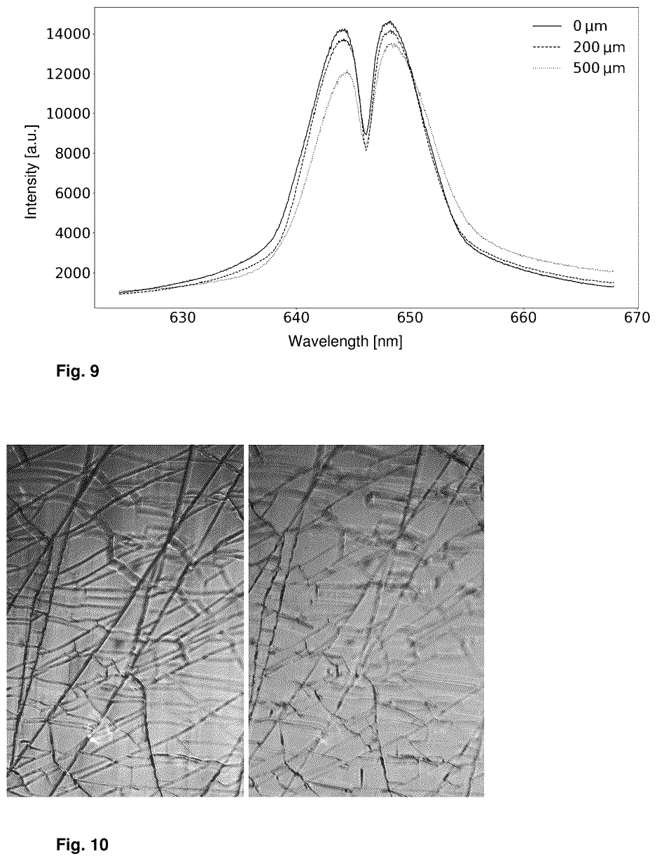

FIG. 9 Spectral behavior of f-PCS with a sublayer of 100 nanometers of SiO₂ when strained parallel to the lattice orientation;

FIG. 10 Surface of an f-PCS with a sublayer of 100 nanometers of SiO₂. The image on the left is in the relaxed state and the image on the right is in the strained state (in this case 5%).

### LIST OF REFERENCE SYMBOLS

1 substrate layer
2 nanostructured waveguide layer
3 waveguide layer portions
4 stretch channels
5 sublayer
6 superlayer

1. A flexible photonic crystal slab, wherein said slab has an optical resonance wavelength change of less than 0.2%, normalized to the percentage strain, wherein the flexible photonic crystal slab comprises a flexible substrate layer (1) and a nanostructured waveguide layer (2), wherein the waveguide layer (2) comprises portions (3) which are bounded by strain grooves (4), and wherein the portions (3) have a size between 2 μm and 1 mm.

2. The flexible photonic crystal slab according to claim 1, wherein the nanostructured waveguide layer (2) is formed from at least one material selected from the group consisting of titanium dioxide (TiO₂), niobium pentoxide (Nb₂O₅) and tantalum pentoxide (Ta₂O₅).

3. The flexible photonic crystal slab according to claim 1, wherein the stretchable substrate layer (1) also has a nanostructure.

4. The flexible photonic crystal slab according to claim 1, wherein the flexible photonic crystal slab has at least one sublayer (5) in addition to the stretchable substrate layer (1) and the nanostructured waveguide layer (2).

5. The flexible photonic crystal slab according to claim 4, wherein the at least one sublayer (5) is a low-index layer.

6. The flexible photonic crystal slab according to claim 4, wherein the sublayer (5) is formed from the material silicon dioxide (SiO₂).

7. The flexible photonic crystal slab according to claim 1, wherein the flexible photonic crystal slab has at least one superlayer (6).

8. The flexible photonic crystal slab according to claim 7, wherein the material for the superlayer is selected from the group consisting of gold (Au) and silicon dioxide (SiO₂).

9. A method for producing the flexible photonic crystal slab according to claim 1, comprising the following steps:
i. forming the flexible substrate layer by:
a. casting a master mold,
b. degassing and
c. then allowing to harden;
ii. optionally, depositing a sub-layer on the flexible substrate layer formed in step i by the method of cathode sputtering;
iii. depositing a high-index waveguide layer on the flexible substrate layer produced in step i or in step ii by the method of cathode sputtering;
iv. producing the strain grooves in the waveguide layer by
a. mechanical loading or
b. lithographic methods or
c. with the aid of masks,
whereby strain grooves in the range of 0.5 μm to 1 mm are specifically set in the lithographic method (iv. b.) or the use of masks (iv. c.).
